(19) United States
(12) Patent Application Publication
(10) Pub. No.: US 2012/0135141 A1
(43) Pub. Date: May 31, 2012

(54) POLYMERIZATION ON PARTICLE SURFACE WITH REVERSE MICELLE

(75) Inventors: Jackie Y. Ying, Singapore (SG); Nikhil R. Jana, Singapore (SG)

(73) Assignee: AGENCY FOR SCIENCE, TECHNOLOGY AND RESEARCH, Singapore (SG)

(21) Appl. No.: 12/674,670

(22) PCT Filed: Aug. 22, 2008
(86) PCT No.: PCT/SG2008/000308

§ 371 Date: Feb. 22, 2010

Related U.S. Application Data
(60) Provisional application No. 60/935,644, filed on Aug. 23, 2007.

(51) Int. Cl. B05D 7/24; C08K 5/13; B82Y 40/00

(52) U.S. Cl. 427/215; 524/736; 977/847

(57) ABSTRACT

A method of coating particles comprises providing a solution comprising reverse micelles. The reverse micelles define discrete aqueous regions in the solution. Hydrophobic nanoparticles are dispersed in the solution. Amphiphilic monomers are added to the solution to attach the amphiphilic monomers to individual ones of the nanoparticles and to dissolve the individual nanoparticles attached with amphiphilic monomers in the discrete aqueous regions. The monomers attached to the nanoparticles are polymerized to form a polymer layer on the individual nanoparticles within the discrete aqueous regions. The polymerization comprises adding a cross-linker to the solution to cross-link the monomers attached to the individual nanoparticles. The solution for coating individual nanoparticles may comprise a microemulsion comprising a continuous phase and a discrete aqueous region defined by reverse micelles; hydrophobic nanoparticles dispersed in the microemulsion; amphiphilic polymerizable monomers attachable to the hydrophobic nanoparticles; and a cross-linker for polymerizing the monomers.

### CROSS-REFERENCE TO RELATED APPLICATION

This application claims the benefit of U.S. provisional application No. 60/935,644, filed Aug. 23, 2007, the entire contents of which are incorporated herein by reference.

### FIELD OF THE INVENTION

The present invention relates to method of coating particles, particularly methods of coating polymers on nanoparticles.

### BACKGROUND OF THE INVENTION

Nanoparticles including quantum dots (QD) are useful in various applications and fields. However, some nanoparticles have limited application due to their low colloidal stability or low solubility in water. For example, hydrophobic particles are not soluble in water and have limited application in an aqueous environment. The particles may be coated with a hydrophilic outer layer, but with the hydrophilic coating the particles may aggregate and thus have low colloidal stability.

Nanoparticles containing semiconductor, noble metal or metal oxide and having diameters from 1 to 10 nm can have unique size-dependent properties. For example, they are more stable and can emit light with higher intensity, as compared to conventional molecular probes. These nanoparticles can be used in bioimaging and biosensing. However, their use in biological applications is limited due to their low colloidal stability. In conventional techniques, surface adsorbed thiol molecules or modified polymers have been used to stabilize and functionalize nanoparticles. However, the weak interaction between the stabilizer and nanoparticle surface often lead to poor chemical, photochemical and colloidal stability. Thus, attempts have been made to prepare core-shell nanoparticles with a crosslinked shell that would protect nanoparticles from adverse environmental conditions and provide better colloidal stability. Known techniques include silica coating, ligand or polymer bridging, and incorporation of nanoparticles within microparticles. In some cases, the resulting core-shell particles (with diameters of about 50 nm to several microns) are significantly larger in size than the core particles. In some cases, further modification of the particles is required to achieve colloidal stability.

### SUMMARY OF THE INVENTION

It is desirable to coat hydrophobic nanoparticles with a polymer layer to form stable, water-soluble coated nanoparticles. It is also desirable to provide a simple process for forming such particles, and to coat the particles with a polymer that allows further functionalization of the particle surfaces with selected functional groups or biomolecules.

According to aspects of present invention, a thin, crosslinked coating can be provided to protect the core nanoparticles, improve colloidal stability, and introduce chemical functionality on the particle surface for bioconjugation.

It has been discovered that polymerization of acrylate/acrylamide mediated by reverse micelles can be carried out in situ to form polymer-coated nanoparticles. The coated particles may have diameters of about 10 to about 50 nm, and may comprise particle cores formed of metal, metal oxide, or quantum dots with diameters of about 5 to about 20 nm. Samples of coated nanoparticles prepared according embodiments of the present invention exhibited excellent colloidal stability—after exposure to UV light overnight, no particle precipitation was observed in the solution containing sample particles.

In accordance with an aspect of the present invention, there is provided a method of coating particles. The method comprises providing a solution comprising reverse micelles, the reverse micelles defining discrete aqueous regions in the solution; dispersing hydrophobic nanoparticles in the solution; adding amphiphilic monomers to the solution to attach the amphiphilic monomers to individual ones of the nanoparticles and to dissolve the individual nanoparticles attached with amphiphilic monomers in the discrete aqueous regions; and polymerizing the monomers attached to the nanoparticles to form a polymer layer on the individual nanoparticles within the discrete aqueous regions, the polymerizing comprising adding a cross-linker to the solution to cross-link the monomers attached to the individual nanoparticles. The monomers may comprise an acrylic monomer. The cross-linker may comprise an acrylamide. The polymerization may comprise adding a radical initiator to the solution to initiate polymerization of the monomers. The reverse micelles may comprise reverse micelles formed by a phenol ethoxylate and cyclohexane. The phenol may be nonyl phenol. The nanoparticles may comprise crystals. The nanoparticles may comprise quantum dots, metal, or metal oxide, such as Ag, Fe₃O₄, or CdSe/ZnS. The solution may have a pH of about 7. The solution may be at a temperature of about 300 K. The nanoparticles may have an initial diameter in the range of from about 5 to about 20 nm. The polymerization may be terminated at a selected time so that the polymer coated nanoparticles have a selected diameter in the range of from about 10 to about 50 nm.

In accordance with another aspect of the present invention, there is provided a solution for coating individual nanoparticles. The solution comprises a microemulsion comprising a continuous phase and a discrete aqueous region defined by reverse micelles; hydrophobic nanoparticles dispersed in the microemulsion; amphiphilic polymerizable monomers attachable to the hydrophobic nanoparticles; and a cross-linker for polymerizing the monomers. The microemulsion may comprise a phenol ethoxylate and cyclohexane. The phenol may be nonyl phenol. The nanoparticles may comprise crystals. The nanoparticles may comprise quantum dots, metal, or metal oxide, such as the nanoparticles comprise Ag, Fe₃O₄, or CdSe/ZnS. The nanoparticles may have a diameter in the range of about 5 to about 20 nm. The solution may have a pH of about 7. The solution may be at a temperature of about 300 k.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic diagram for a process of coating a particle, exemplary of an embodiment of the present invention;

FIGS. 2 and 3 are line diagrams showing the absorbance of sample particles in different environments;

FIGS. 4 to 7 are bar diagrams showing the size distribution of different sample particles. In each figure, the particle of the highest intensity is 100%;

FIG. 8 is a line diagram showing the absorbance of sample particles; and

FIG. 9 is an emission spectrum of sample particles (a.u.=arbitrary unit).

### DETAILED DESCRIPTION

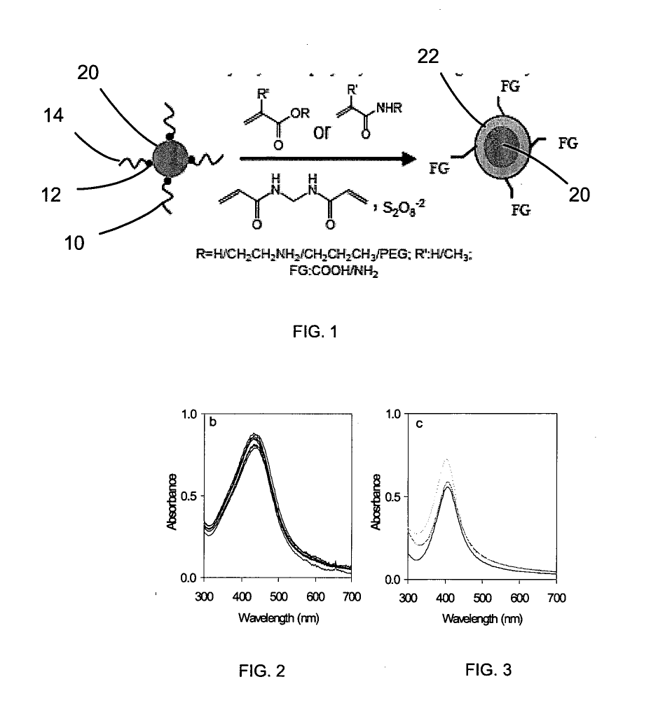

In an exemplary embodiment of the present invention, coated nanoparticles are formed as illustrated in FIG. 1.

In the exemplary reaction route illustrated in FIG. 1, a solution containing reverse micelles 10 and nanoparticles 20 is provided.

A micelle is an aggregate of amphiphilic or surfactant molecules dispersed in a liquid colloid. Each of the amphiphilic/surfactant molecules has a hydrophilic “head” end and a hydrophobic “tail” end. The tails of the micelle may include hydrocarbon groups, and the heads of the micelle may include charged (anionic or cationic) groups or polar groups. In a polar solvent such as an aqueous liquid, an aggregate of the micelle molecules typically form a normal micelle with the hydrophilic head ends extending outward and in contact with the surrounding solvent, sequestering the hydrophobic tail ends in the micelle centre (this type of micelle is also referred to as oil-in-water micelle). In a non-polar solvent, the formation of a reverse (also referred to as “inverse”) micelle is energetically favored, where the heads extend inwardly toward the micelle center and the tails extend outward from the center (also referred to water-in-oil micelle). The more charged the head groups, the less likely reverse micelles will form, as highly charged head groups would be more repulsive of each other when they are in close proximity, due to electrostatic interactions. Thus, the reverse micelles define discrete aqueous regions at their centers.

Typically, micelles have a generally spherical shape. However, suitable reverse micelles may also have other shapes such as ellipsoids, cylinders or the like.

Formation of reverse micelle is well known in the art. Reverse micelles may for example be formed in a solution that contains a non-polar solvent and a suitable surfactant. The non-polar solvent may be an organic solvent. The surfactant may have a terminal group that is hydrophilic and another terminal group that is lipophilic.

For example, in some embodiments, reverse micelles 10 may be formed in a solution containing the non-polar solvent cyclohexane and the surfactant phenyl ether or phenol ethoxylate. The phenol or phenyl in the surfactant may be a nonyl phenol or nonyl-phenyl. For instance, the surfactant may include an Igepal™ liquid material, such as Igepal CO-520 (₄-(C₉H₁₉)C₆H₄O(CH₂CH₂O)₄CH₂CH₂OH, branched polyoxyethylene(5)nonyl phenyl ether).

The solution may also include a polar solvent such an aqueous solvent, which will form a discrete aqueous phase in the solution. It is assumed that an aqueous solvent is used in the following discussion. The aqueous solvent will be dispersed in the discrete aqueous regions defined by the reverse micelles, by self-assembly.

A discrete aqueous region surrounded by the reverse micelle is sometimes referred to as being encapsulated by the micelle, meaning that the aqueous region is protected by the reverse micelle, although a hydrophilic material can still be introduced into the aqueous region without breaking-up the reverse micelle.

As shown in FIG. 1, the hydrophilic heads 12 of the reverse micelle 10 point toward the center and define a discrete aqueous region. The hydrophobic tails 14 of reverse micelle 10 are directed outward away from the center.

The nanoparticles can be any nano-sized particles with a surface to which the selected precursors can attach, including hydrophobic nanoparticles. For example, the particles may have a crystal structure, and may include crystals such as semiconductor crystals, and quantum dots such as CdSe QDs or ZnS-CdSe QDs. The nanoparticles may also include metals or metal oxides, such as Ag or Fe₃O₄. The particles may be fluorescent or magnetic. For clarity, it should be understood that when the linking term “or” is used in a list of items herein, a listed item may be present by itself or in combination with one or more other listed items, when the combination is possible.

The nanoparticle concentration in solution may be milimolar to micromolar, and the micelle concentration may be millimolar, for example, Igepal surfactant may be present at a concentration of about 1 mL lgepal surfactant/10 mL solution.

The nanoparticles to be coated may be formed in any manner and may be obtained from a commercial source. In some applications, the formation of the uncoated nanoparticles and the coating process may be integrated.

The hydrophobic nanoparticles may be initially dispersed in the non-polar (or “oil”) region of the solution containing reverse micelles.

As illustrated in FIG. 1, an amphiphilic precursor for a polymer, typically in the form of a monomer precursor, and a cross-linker for crosslinking the precursor to form polymers may be added to the solution.

The monomer precursor may include any suitable polymerizable monomers that are amphiphilic and able to attach to the surfaces of individual nanoparticles

In some applications, the monomers may be selected to form polymers such as polystyrene, polyacrylate, polyimide, polyacrylamide, polyethylene, polyvinyl, polydiacetylene, polyphenylene-vinylene, polypeptide, polysaccharide, polysulfone, polypyrrole, polyimidazole, polythiophene, polyether, or polyphosphate, or the like.

For example, to form polyacrylate, an acrylate monomer may be used. The acrylate monomer may have the chemical structures shown above the arrow in FIG. 1, where R may be H, CH₂CH₂NH₂, CH₂CH₂CH₃, or polyethylene glycol (PEG); and R′ may be H or CH₃.

Typically, the monomer concentration will be in the millimolar range. In one embodiment, the solution may contain about 0.2 mM of the monomer.

The monomers may attach themselves to the surfaces of individual nanoparticles before or during polymerization, thus forming a layer of monomers on the particle surface. A molecule is attached to a surface when it binds to the surface by, for example, a chemical bond, or another attractive force.

When the particles are coated with a layer of the amphiphilic molecules, it is postulated that the coated particles are driven toward the discrete aqueous regions defined by the reverse micelles as the particle surfaces are now hydrophilic.

The cross-linker may be any suitable cross-linker that can crosslink the particular monomers to form the desired polymer. Advantageously, the cross-linker is hydrophilic. For example, for acrylate monomers, acrylamide monomers may be used as the cross-linker. In one embodiment, about 5 to about 10 mol % of methylenebisacrylamide may be added to the solution as the cross-linker. In another embodiment, the solution may contain about 0.01 to about 0.2 mM of the crosslinker.

In some embodiments, the molar ratio of the cross-linker to the monomer may be less than about 1:10.

To increase reaction rate, a catalyst may be added to the solution. For example, a basic catalyst such as tetramethyl ethylene diamine or ammonia may be used.

The surfactant, nanoparticles, monomers and cross-linker may be added to the solution in any order.

Any of the above mentioned reagents such as the monomers and the crosslinker may be first dissolved in an aqueous solvent and then added to the reverse micelle solution with the aqueous solvent.

Before initiating the polymerization process, it may be desirable that the reaction solution is clear, i.e., there is no visible aggregation or precipitation in the solution. A clear solution indicates that no flocculation has occurred in the solution, and the nanoparticles and other ingredients are well dispersed and trapped in the centers of the reverse micelles. This can happen as the hydrophobic ends of the amphiphilic monomers are attached to the surface of the nanoparticles and the hydrophilic ends of the monomers are attracted to the hydrophilic heads at the micelle center, and thus the particles coated with the amphiphilic monomers are dispersed and dissolved in the aqueous phase. While polymerization may still be performed with a non-clear solution, the presence of relatively large sized aggregates of the particles before polymerization may result in a coated-particle size distribution that may be undesirable in some applications.

Thus, the surfactant and monomers may be added in a sufficient amount so that the solution is visually clear before polymerization. If after the addition of the initial amount of surfactant and monomers, the solution is not clear, additional surfactant or monomer may be added to make it clear, depending on the reasons for the unclear solution. For example, the solution may be unclear because the total volume of the aqueous regions defined by the reverse micelles is too small to dissolve all of the particles coated with the amphiphilic monomers. In this case, more surfactant may be added to increase the total volume of the aqueous phase. It is also possible that the solution is unclear because the amount of monomers in the solution is too small to sufficiently coat the surfaces of the particles in the solution. In this case, more amphiphilic monomers can be added to increase the coverage of the particle surface by the monomers.

The monomers are polymerized on the surface of the nanoparticles within the aqueous regions defined by the reverse micelles. Polymerization may be initiated by adding an initiator. The initiator may include a persulfate initiator, such as peroxodisulfate as illustrated in FIG. 1. In one embodiment, a suitable amount of ammonium persulfate may be used as the initiator.

During polymerization, the polymer molecules are crosslinked by the cross-linker.

After a pre-determined or selected period of time, polymerization may be terminated, such as by adding a material that will cause fracture or disruption of the reverse micelle structure, thus exposing the materials trapped inside the aqueous phase to the non-polar solvent. For example, ethanol may be added to terminate the polymerization process by precipitating out the coated particles.

After the polymerization is terminated or completed, the hydrophobic nanoparticles 20 are coated with a polymer layer 22 with a hydrophilic outer surface, where the polymers in the coating layer 22 are cross-linked. The coating also can be functionalized with functional groups (FG), such as COOH or NH₂.

The coated particles may then be extracted from the reaction solution, and may be further treated such as purified or washed, as can be understood by those skilled in the art. The coated-particles may also be further processed or used for various applications.

In some embodiments, the nanoparticles may be pre-treated such as purified so that their surfaces are free or substantially free of free ligands. With free ligands on the particle surface, the particles may tend to flocculate, thus forming insoluble aggregates.

In some embodiments, it may be advantageous to use highly polar and water-soluble monomers, to form water soluble nanoparticles.

It may also be advantageous if the concentrations of the monomers in the solution are sufficiently high for efficient ligand exchange with the surfactant molecules in the micelles. When the concentration of the monomers is high, it may be desirable to terminate the polymerization process before complete polymerization in order to obtain particles with a desired size distribution.

In some embodiments, the polymerization process may be terminated before the monomers are completely polymerized. Allowing the polymerization to proceed to completion may result in substantial inter-particle crosslinking in some embodiments, which in turn will result in flocculation of the coated particles.

In some embodiments, where the polymer coated nanoparticle may possibly form a gel if the concentration of the cross-linker is too high, the concentration of the cross-linker should be limited to below the gel-forming threshold. For example, in some embodiments, the molar ratio of the cross-linker to the monomer may be limited to less than about 1:10, to prevent excessive cross-linking.

The process and method described herein can provide certain benefits. With the use of an amphiphilic surfactant, the initially hydrophobic nanoparticles and hydrophilic/hydrophobic acrylates can be both solublized in the reaction medium, and polymerization can proceed substantially homogeneously. Polymerization of the coating on the nanoparticle within a reverse micelle can also conveniently provide certain benefits. For example, ligand exchange confined within individual, discrete aqueous regions during polymerization does not lead to particle aggregation among particles dispersed within different reverse micelles. Polymerization occurs within individual reverse micelles, thus restricting the polymer-coated nanoparticles to the aqueous regions (also referred to as domains), which may have diameters of about 10 to about 50 nm. Particle aggregation can thus be reduced or minimized. It is also possible to conveniently terminate the polymerization process at a selected time. The coated particles can be conveniently extracted, such as by precipitation and isolation. For example, after a desired period of polymerization, a suitable solvent such as ethanol may be added to the reaction mixture to break the reverse micelles, thus releasing the coated nanoparticles therefrom.

The polymerization conditions, such as the properties and characteristics of the monomer, the monomer concentration, and the reaction time, may be adjusted or optimized to control particle size of the resulting coated particles. For instance, the conditions may be optimized to obtain small particles, for example, with diameters of less than 100 nm or about 20 nm that are of high water solubility and good colloidal stability in various buffers and ionic media described in the Examples below.

It is possible to use different monomers, or mixture of monomers, and nanoparticles to prepare coated particles that are of different functionalities with surface groups such as primary amine, carboxylate, polyethylene glycol (PEG), amine-PEG, carboxylate-PEG, or the like.

The nanoparticles may be coated with a polymer described above, or another material such as an epoxy, silica glass, silica gel, siloxane, hydrogel, agarose, cellulose, or the like.

Embodiments of the present invention, their features and benefits, are further illustrated the examples described below.

### EXAMPLES

The materials used in the Examples were obtained as follows, unless otherwise specified, where the company names enclosed in parentheses are the provider of the corresponding chemical.

Tween 80, oleic acid, 4-(N-maleimidomethyl)cyclohexane-1-carboxylic acid 3-sulfo-N-hydroxysuccinimide ester (MAL-cyclohex-NHS), and biotinamidocaproate N-hydroxysuccinimide ester (NHS-biotin) were obtained from Sigma™.

2-aminoethyl methacrylate hydrochloride, and ethylene glycol methyl ether methacrylate were obtained from Aldrich™.

N-(3-aminopropyl)methacrylamide hydrochloride, and poly(ethylene glycol) monomethacrylate, were obtained from Polysciences™.

N,N′-methylenebisacrylamide, ammonium persulfate, N,N,N′,N′-tetramethyl ethylene diamine, were obtained from Alfa Aesar™.

TAT peptide with terminal cysteine group (95% purity) was obtained from GenScript™.

Each of the above chemicals were used as-received without further purification.

The following instruments were used to obtain the results described in the Examples.

Visible UV light absorption spectra were detected and recorded using Agilent 8453™ spectrophotometer with a 1-cm quartz cell.

Fluorescence spectra were measured using Jobin Yvon Horiba Fluorolog™ fluorescence spectrometer.

Quantum yields (QY) of the sample QDs were determined by measuring integrated fluorescence intensity of the QDs, with a flourescein reference (QY=97%) under 470-nm excitation.

FEI Tecnai G² F20™ electron microscope (200 kV) was obtaining TEM images. Samples were prepared by placing a drop of the diluted particle solution on carbon-coated copper grid.

A Brucker™ AV-400 spectrometer (400 MHz) was used to obtain NMR (Nuclear magnetic resonance) images from concentrated solution (5 to 10 mg/mL) of coated particle dissolved in D₂O.

A laser light scattering system, BI-200SM™, provided by Brookhaven Instruments Corp, was used for dynamic light scattering (DLS) analysis of the samples, which were filtered through a PALL™ syringe filter (0.1-μm pores) before analysis.

Cell imaging was performed using Olympus microscope IX71 with a DP70 digital camera.

Confocal fluorescence imaging was performed using an Olympus Fluoview 300™ confocal laser scanning system with 488-nm laser excitation.

### Example I

### Synthesis of Nanoparticles

Near-monodisperse Ag nanoparticles with diameters of about 3 to about 4 nm were prepared in toluene using oleic acid as particle stabilizer.

Near-monodisperse Fe₃O₄ nanoparticles with diameters of about 4 to about 15 nm were prepared by high-temperature pyrolysis of Fe(II) carboxylate salt in octadecene.

CdSe was prepared by high-temperature pyrolysis of carboxylate precursors of Cd in octadecene. CdSe nanoparticles were purified from free ligands, and capped by ZnS shell at 200° C. in octadecene via the alternate injection of Zn stearate in octadecene and elemental S dissolved in octadecene.

The particles were purified from free ligands using a standard precipitation-redispersion procedure.

### Example II

### Coating Particles with Polymer within Reverse Micelles

The nanoparticles prepared in Example I were introduced into Igepal-cyclohexane reverse micelle solutions and coated with polymer as follows.

The hydrophobic nanoparticles were introduced to 10 mL of an Igepal-cyclohexane reverse micelle solution (1 mL of Igepal in 9 mL of cyclohexane). The particle concentration was adjusted using the absorbance value at the first absorption peak for ZnS-CdSe, the plasmon absorbance value at 410 nm for Ag, and the absorbance value at 400 nm for Fe₃O₄ using an optical path length of 1 cm. The absorbance was about 0.3 to about 0.5 for ZnS-CdSe, about 1.0 to about 2.0 for Ag, and about 0.5 to 1.0 for Fe₃O₄. In two separate vials, about 0.2 mM of acrylic monomers or their mixture (dissolved in 100 μL of water) and 0.01 to 0.2 mM of methylenebisacrylamide (dissolved in 200 μL of water by 10 min of sonication) were prepared and mixed with the nanoparticle solution. Next, 50 μL of tetramethyl ethylene diamine were added as a basic catalyst. If the solution was not clear, lgepal was added in 1 to 2 mL allotments until the solution were optically clear. The solution was placed in three flasks under oxygen-free atmosphere by purging with nitrogen for 10 min. Finally, ammonium persulfate solution (5 mg dissolved in 100 μL of water) was injected as a radical initiator to begin the polymerization.

The polymerization was continued at room temperature for about one hour. Coated particles were then precipitated with the addition of a few drops of ethanol. The coated particles were washed with chloroform and ethanol, and dissolved in water or a buffer solution.

A solution containing sample coated ZnS-CdSe particles was exposed to UV light overnight. After exposure, no particle precipitation was observed in the solution.

### Example III

### Bioconjugation

Biotin and peptide were conjugated to the polymer-coated particles prepared in Example II, using conventional conjugation reagents. No fluorescence quenching of ZnS-CdSe and colloidal instability of particles were observed in the presence of the conjugation reagents and during the purification steps. Biotin was conjugated to primary amine functionalized particles using NHS-biotin. Thiolated TAT peptide was conjugated to primary amine functionalized particles using MAL-cyclohex-NHS. For the conjugation reactions, 0.50 mL of the polymer-coated particle solution was mixed with 1 mL of borate/PBS buffer (pH 7.0). Next, NHS-biotin solution (1 mg/mL of dimethyl formamide (DMF)) or bifunctional MAL-cyclohex-NHS (3 to 5 mg dissolved in 100 μL of DMF) was introduced. Biotinylated particles were dialyzed after 2 hours of incubation, and preserved at 4° C. MAL-cyclohex-NHS-conjugated particles were passed through a Sephadex G25 column after 2 hours of incubation to separate the free reagents from the particles. The solution of activated particles was immediately mixed with 200 μL of TAT peptides (2 mg/mL), and kept at 4° C. overnight. The peptide-conjugated particles were then purified from free peptides by overnight dialysis. They were diluted with tris buffer (pH 7.0) and preserved at 4° C.

### Example IV

### Cell labeling

HepG2 cells grown in tissue culture flask were subcultured in 24-well tissue culture plate (with a culture medium volume of 0.5 mL for each plate). For confocal microscopy studies, the cells were cultured on a circular cover slip placed under tissue culture plate. The cells were attached to the tissue culture plate/cover slip after overnight culture. They were then incubated with 10-100 μL of ZnS-CdSe solution (about 0.1 mg/mL) for about 1 to 2 hours. They were washed with PBS buffer, followed by cell culture media.

NMR spectra of polymer-coated (a) ZnS-CdSe and (b) Ag. In both cases, acrylic acid and methylenebisacrylamide (5%) were used as polymer precursor and crosslinker, respectively. The broad peaks at 1.3 to 2.4 ppm were due to polyacrylate. The weaker band at 4.1 to 4.3 was due to the methylene group of methylenebisacrylamide.

FIG. 2 shows the absorbance of sample polyacrylate-coated Ag particles in phosphate buffers with a pH from 3 to 11, as a function of excitation wavelength. The peak and absorbance indicate that the particles are soluble.

FIG. 3 shows the absorbance of sample polyacrylate-coated Ag particles dispersed in solutions that contained NaCl of a concentration of 0.5 (the line with the lowest peak), 1.0 (the line with the peak in the middle), or 2.0 M (the line with the highest peak) respectively. The particles are soluble in high salt condition.

Gel electrophoretic studies of polyacrylamide-coated cationic ZnS-CdSe quantum dots were also conducted, which showed that these particles were attracted towards the cathode.

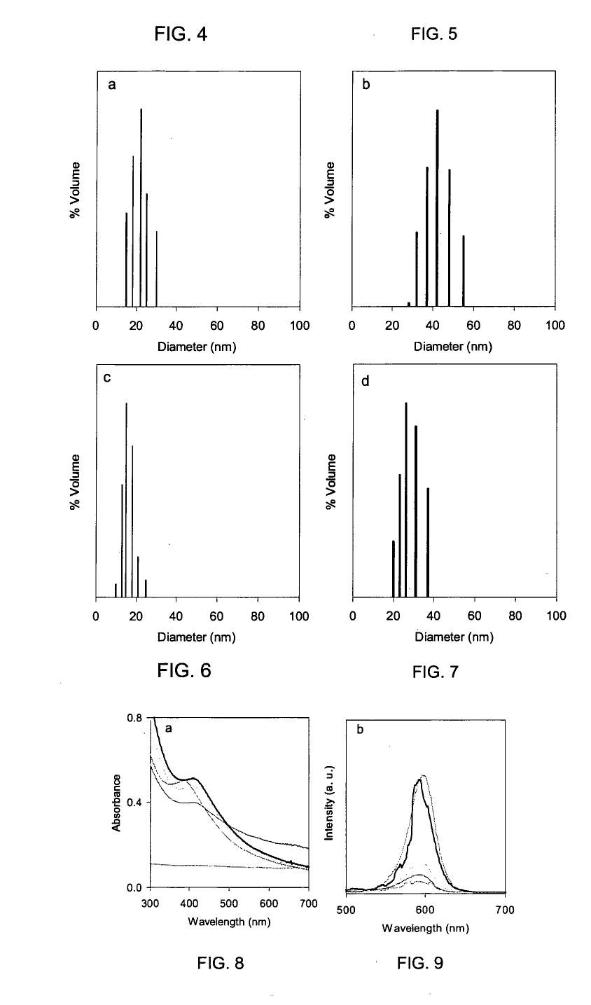

FIGS. 4 to 7 show that the particle size distribution of polymer-coated nanoparticles, where the nanoparticle cores are Ag (FIG. 4), Fe₃O₄ (FIG. 5), green ZnS-CdSe (FIG. 6), and red ZnS-CdSe (FIG. 7) respectively. These data were measured using a depolarized light scattering (DSL) technique and shows the size as relative % distribution of coated particles.

FIGS. 8 and 9 show the precipitation of biotinylated Ag (FIG. 8) and ZnS-CdSe (FIG. 9) particles in different solutions. The solutions contained different level of Streptavidin (0.0, 0.5, 1.0, or 5.0 μg/mL respectively). The precipitated particles were separated by centrifugation before the spectral measurements. The control experiment with BSA (10 to 500 μg/mL) did not show particle precipitation.

Other tests were also conducted on sample polymer-coated particles prepared according to an embodiment of the present invention. Characteristic proton NMR peaks of polyacrylate/polyacrylamide were observed in the sample particles but no trace of the long-chain hydrocarbon surfactants that were present in the reaction mixture were found in the resulting product particles. This result confirmed that the original surfactant stabilizer was completely displaced by the polymer.

No observable free monomers were found on the particle surface. The absence of free monomers indicates that the precursors have been either converted to polymers or washed away during the purification steps. Transmission electron microscopy (TEM) were performed on the sample particles and the results indicated that most of the coated particles were well isolated. As the TEM results can show the sizes of the core crystallite but not the overall sizes of the coated particles, the samples were also analyzed using a DLS technique to determine the overall sizes of the coated particles. It was found that the overall sizes were in the range of about 10 to about 50 nm. The overall sizes were dependent on the core sizes (diameters). The polymer coating was found to have a thickness of larger than about 5 nm.

Some particle aggregates were observed in the sample products.

In the sample coated particles, the particle surface were either positively or negatively charged, depending on the functional groups present in the coating layer. The surface charge varied from about +30 to about −40 mV, depending on the pH value of the solution of the final reaction mixture.

Polyacrylamide gel electrophoresis tests showed that the sample particles would migrate under electric field depending on their surface charge.

The colloidal stability of the sample polymer-coated particles was tested in the presence of salts, chemical reagents, UV light, and at various pHs. Compared to conventional ligand (mercapto propionic acid) exchanged nanoparticles, the sample polyacrylate-coated particles had superior colloidal stability under a wide range of pH values and high salt concentrations, and in the presence of conventional chemical linking reagents. The sample polymer-coated particles were found stable in a solution at room temperature in open atmosphere for over a year without any sign of precipitation.

The cellular uptake of sample polymer-coated particles varied significantly depending on the surface charge and whether PEG functional groups were present. Positively charged particles were readily taken up by the cells, unlike the negatively charged particles. Introducing PEG on the positively charged particle surface significantly reduced the cellular uptake.

Primary amine and carboxylate groups present on the surface of a coated particle can be used for further bioconjugation with biomolecules of interest for bioimaging and biosensing applications.

For example, antibody-functionalized polymer-coated ZnS-CdSe (quantum yield=10-25%) and Ag were prepared using sample polymer-coated particles.

TAT peptide conjugated ZnS-CdSe were also prepared, which may be used for cell labeling applications. Tests showed that functionalization of polymer-coated particles with TAT peptides increased the cellular uptake, but most of the sample particles entered into the lysosomes, and only partial perinuclear localization was observed. This indicated that a fine tuning in particle surface property may be necessary to inhibit endosomal uptake.

Polyacrylate-coated particles may be used to derive a variety of biofunctionalized nanoparticles and quantum dots. By optimizing the surface chemistry of the coated particles, their cellular uptake can be controlled. Different coated particles may be formed to for receptor-based cell targeting or subcellular labeling applications.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation.

The invention, rather, is intended to encompass all such modification within its scope, as defined by the claims.

1. A method of coating particles, comprising:
providing a solution comprising reverse micelles, said reverse micelles defining discrete aqueous regions in said solution;
dispersing hydrophobic nanoparticles in said solution;
adding amphiphilic monomers to said solution to attach said amphiphilic monomers to individual ones of said nanoparticles and to dissolve said individual nanoparticles attached with amphiphilic monomers in said discrete aqueous regions; and
polymerizing said monomers attached to said nanoparticles to form a polymer layer on said individual nanoparticles within said discrete aqueous regions, said polymerizing comprising adding a cross-linker to said solution to cross-link said monomers attached to said individual nanoparticles.

2. The method of claim 1, wherein said monomers comprise an acrylic monomer.

3. The method of claim 1, wherein said cross-linker comprises an acrylamide.

4. The method of claim 1, wherein said polymerizing comprises adding a radical initiator to said solution to initiate polymerization of said monomers.

5. The method of claim 1, wherein said reverse micelles comprise reverse micelles formed by a phenol ethoxylate and cyclohexane.

6. The method of claim 5, wherein said phenol is nonyl phenol.

7. The method of claim 1, wherein said nanoparticles comprise crystals, quantum dots, a metal, or a metal oxide.

8. (canceled)

9. (canceled)

10. (canceled)

11. The method of claim 1, wherein said nanoparticles comprise Ag, Fe₃O₄, or CdSe/ZnS.

12. The method of claim 1, wherein said solution has a pH of about 7.

13. The method of claim 1, wherein said solution is at a temperature of about 300 K.

14. The method of claim 1, wherein said nanoparticles have an initial diameter in the range of from about 5 to about 20 nm.

15. The method of claim 1, wherein said polymerizing is terminated at a selected time so that said polymer coated nanoparticles have a selected diameter in the range of from about 10 to about 50 nm.

16. A solution for coating individual nanoparticles, comprising:
a microemulsion comprising a continuous phase and a discrete aqueous region defined by reverse micelles;
hydrophobic nanoparticles dispersed in said microemulsion;
amphiphilic polymerizable monomers attachable to said hydrophobic nanoparticles; and
a cross-linker for polymerizing said monomers.

17. The solution of claim 16, wherein said microemulsion comprises a phenol ethoxylate and cyclohexane.

18. The solution of claim 17, wherein said phenol is nonyl phenol.

19. The solution of claim 16, wherein said nanoparticles comprise crystals, quantum dots, a metal, or a metal oxide.

20. (canceled)

21. (canceled)

22. (canceled)

23. The solution of claim 16, wherein said nanoparticles comprise Ag, Fe₃O₄, or CdSe/ZnS.

24. The solution of claim 16, wherein said nanoparticles have a diameter in the range of about 5 to about 20 nm.

25. The solution of claim 16, wherein said solution has a pH of about 7.

26. The solution of claim 16, wherein said solution is at a temperature of about 300 k.
